(19) United States
(12) Patent Application Publication
(10) Pub. No.: US 2007/0285413 A1
(43) Pub. Date: Dec. 13, 2007

(54) DOUBLE-SIDED DISPLAY

(75) Inventors: SHIH-FANG WONG, Tu-Cheng (TW); TSUNG-JEN CHUANG, Tu-Cheng (TW); JIAN-LIN LIU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/741,750

(22) Filed: Apr. 29, 2007

(30) Foreign Application Priority Data
May 19, 2006 (CN) 200610060715.1

(51) Int. Cl. G09G 5/00; G06F 3/038

(52) U.S. Cl. 345/211; 345/1.1

(57) ABSTRACT

A double-side display includes two display screens (101, 101′) mounted back-to-back. The display screens are driven by a first driving circuit (130) and a second driving circuit (160) respectively and share a backlight module (150). The first driving circuit and the second driving circuit receive data that a first data interface (104) and a second data interface (105) transmits from at least two computers correspondingly. The first driving circuit, the second driving circuit and the backlight module receive DC power at suitable voltages supplied from a DC/DC converting circuit (120).

### TECHNICAL FIELD

The present invention relates to displays, and particularly, to a double-sided display.

### RELATED ART

In related art, dual-screen computers have been introduced a lot by documents. Some of them have already been commercially available in the market. These dual-screen computers are provided for a purpose of making a presentation and/or expanding a display area by combining two displays to display a whole image. Such a reference can be made to US patent application No. 20020109662, which is published at Aug. 15, 2002 and titled “DUAL-SCREEN COMPUTER DISPLAY.”

Either being used as presentation devices or to achieve a large display area, the dual display screens of a dual-screen computer are driven to display contents from a same computer (i.e., the dual-screen computer). The dual display screens cannot be used as two independent displays to simultaneously display contents from two computers when needed.

Therefore, there is a need for providing a double-sided display which can be used as two independent displays as well as a presentation device.

### SUMMARY

A double-sided display is provided in accordance with a preferred embodiment. The double-sided display includes: a first display screen and a second display screen mounted back-to-back; a backlight module shared by the first display screen and the second display screen; a first driving circuit and a second driving circuit for driving the first display screen and the second display screen respectively; a first data interface and a second data interface for transmitting data from at most two computers to the first driving circuit and the second driving circuit correspondingly; a DC/DC (direct current to direct current) converting circuit for outputting DC power at suitable voltages to the backlight module, the first driving circuit and the second driving circuit; and a power port for transferring power from an external power source to the DC/DC converting circuit.

Other advantages and novel features will be drawn from the following detailed description with reference to the attached drawings, in which:

### BRIEF DESCRIPTION OF THE DRAWINGS

FIG. 1 is a front view of a double-sided display in accordance with a preferred embodiment of the present invention;

FIG. 2 is a side view of the double-sided display of FIG. 1;

FIG. 3 is a schematic perspective view of the double-sided display of FIG. 1, viewed from one aspect;

FIG. 4 is a schematic perspective view of the double-sided display of FIG. 1, viewed from another aspect;

FIG. 5 is a first schematic circuit diagram of the double-sided display of FIG. 1;

FIG. 6 is a second schematic circuit diagram of the double-sided display of FIG. 1; and

FIG. 7 is a third schematic circuit diagram of the double-sided display of FIG. 1.

### DETAILED DESCRIPTION OF THE EMBODIMENTS

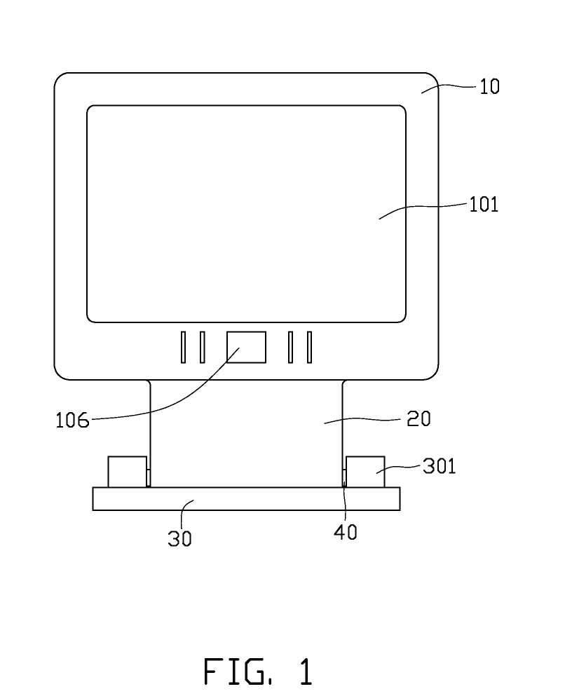

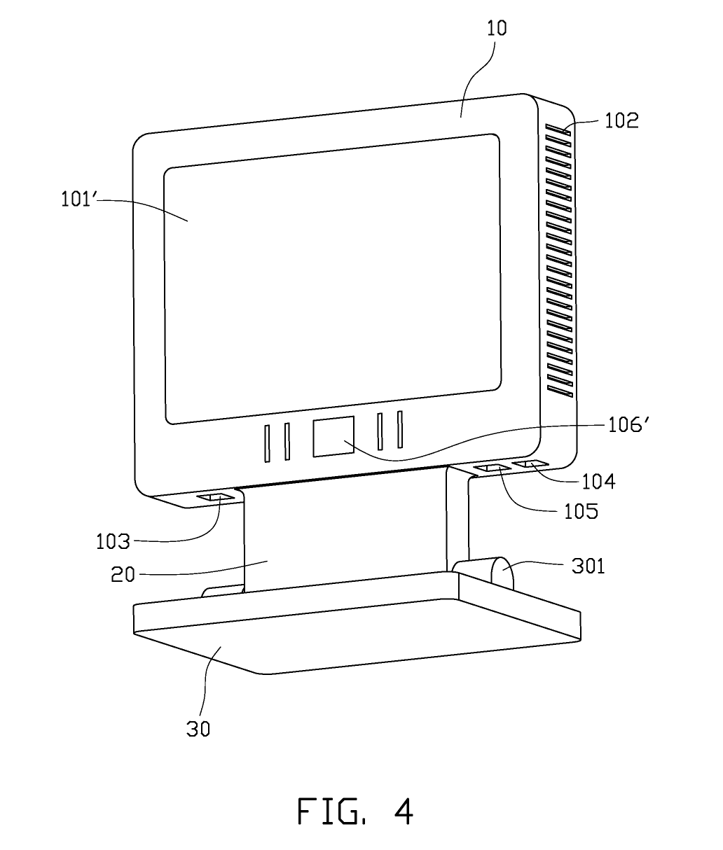

Referring to FIGS. 1 through 4, a double-sided display in accordance with a preferred embodiment includes a display body 10, a supporting arm 20 and a base 30. The supporting arm 20 is used to_support the display body 10 and is rotatably coupled to the base with hinges such that the supporting arm 20 can rotate relative to the base 30. Additionally, the base 30 includes two holders 301. The holders 301 are used for receiving at least one hinge 40 that pivotally connects the supporting arm 20 to the base 30. When an external force that is exerted by a user is greater than a torque of the hinge 40, the supporting arm 20 rotates relative to the base 30; when the external force is released, the hinges 40 fixes the supporting arm 20 relative to the base 112 at an angle.

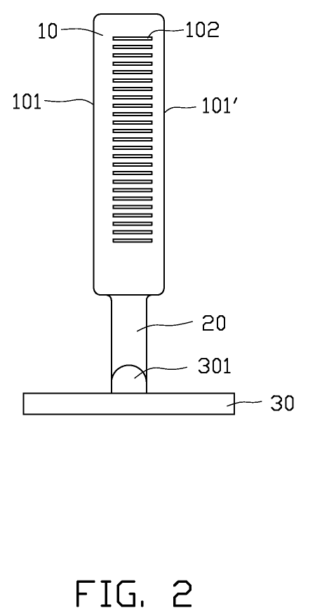

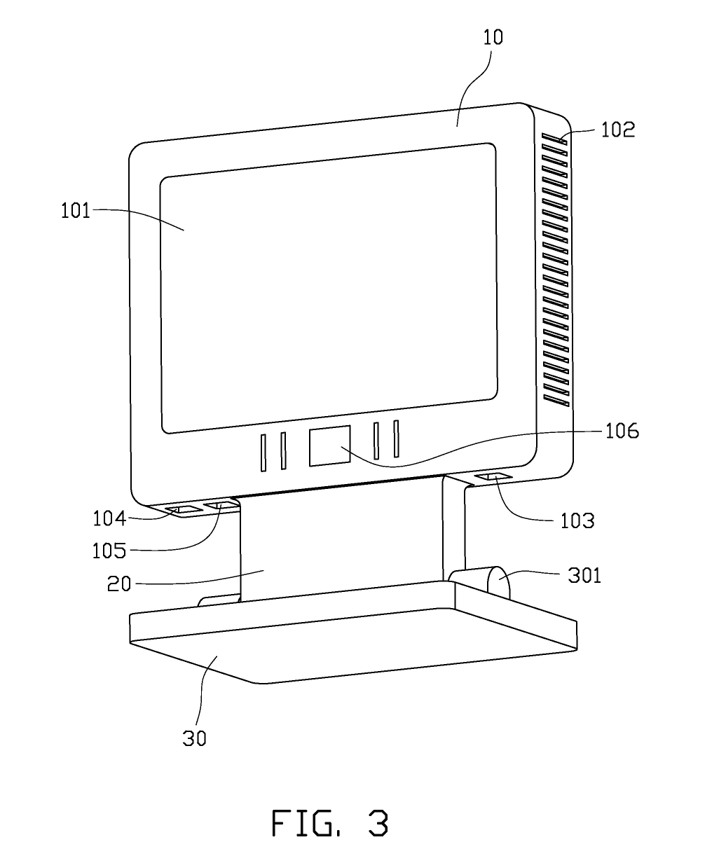

The display body 10 includes two display screens 101 and 101′. The display screens 101 and 101′ are mounted in a back-to-back configuration to allow data to be displayed at a front side, and a back side of the double-sided display. The display body 10 is configured with a power port 103, a first data interface 104 and a second data interface 105. The power port 103 is an AC power port which is connected with an external AC power source (not shown) and to supply power to the double-sided display. The first and second data interfaces 104, 105 are provided to connect the double-sided display with at most two computers (not shown) and to supply data from the at most two computers to the display screen 101 and 101′ correspondingly. In a first embodiment, the display screens 101, 101′ are enabled by a first power button 106 that is configured at a first predetermined location on the display body 10, such as at a bottom portion of the display body 10 as shown in the Figs. In a second embodiment, the display screens 101, 101′ are enabled by two separate power buttons correspondingly; that is, the display screen 101 is controlled by the first power button 106 and the display screen 101′ is controlled by a second power button 106′. The display body 10 is defined with a plurality of thermal dissipation slots 102 for heat dissipation. The thermal dissipation slots 102 are distributed at predetermined locations, such as on sides of the display body 10 as shown in FIGS. 2 and 3.

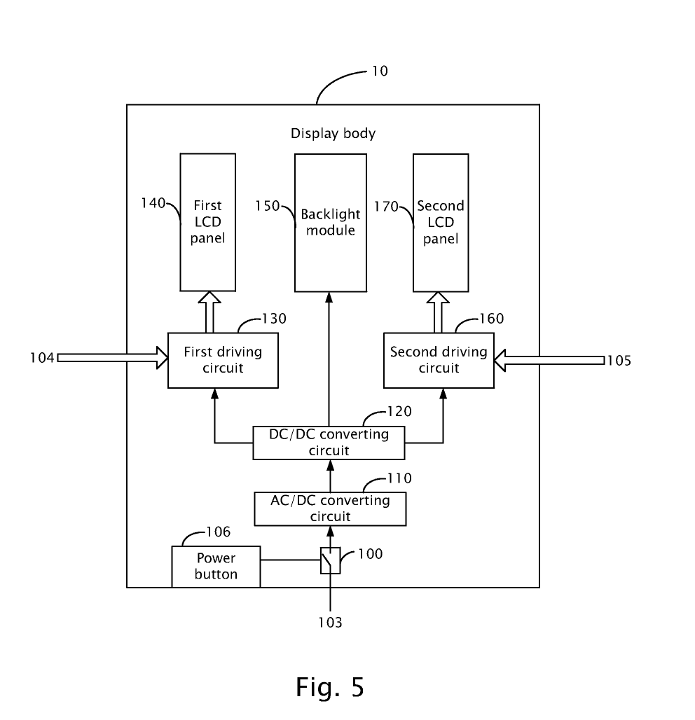

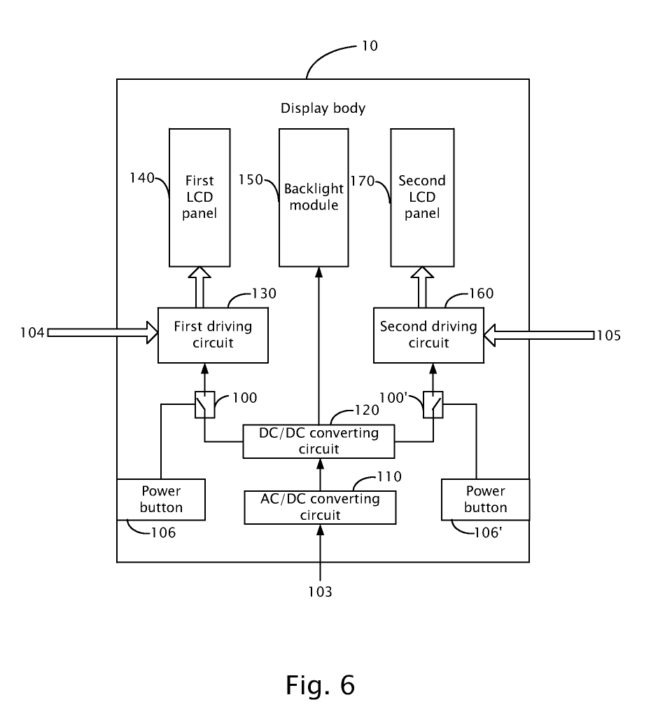

Referring to FIGS. 5 and 6, the power port 103 supplies AC power from the external power source to an AC/DC converting circuit 110 so as to convert the AC power to DC power. The DC power is forwarded to a DC/DC converting circuit 120 to obtain DC power at suitable voltages required by a first and second driving circuits 130, 160, and a backlight module 150 assembled in the display body 10 correspondingly. The first driving circuit 130 is employed to drive a first LCD panel 140 that includes the display screen 101 in accordance with the data received from the first data interface 104. The second driving circuit 160 is employed to drive a second LCD panel 170 that includes the display screen 101′ in accordance with the data received from the second data interface 105. The first and second LCD panel 140, 170 are mounted back-to-back and share the backlight module 150.

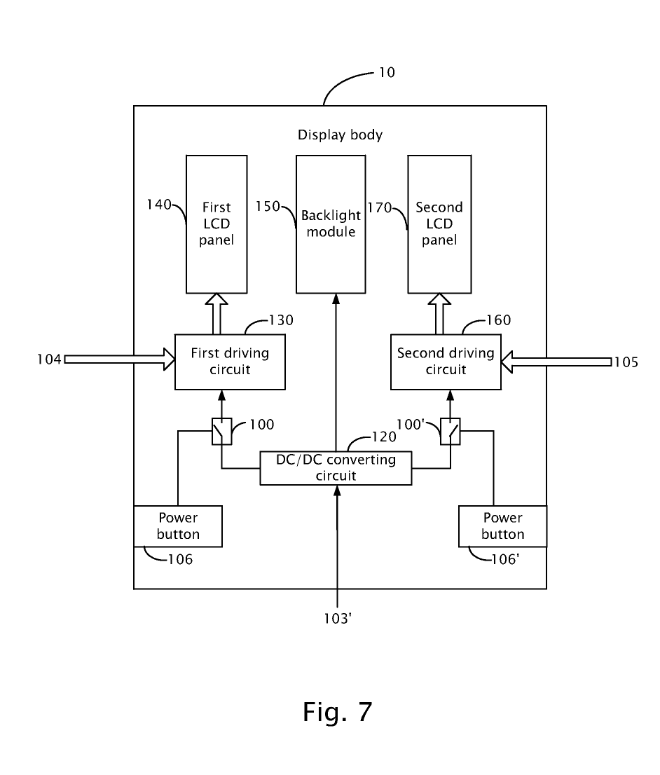

Although FIGS. 5 and 6 both show that the display body 10 includes both the AC/DC converting circuit 110 and the DC/DC converting circuit 120 for power converting, the display body may alternatively only include the DC/DC converting circuit 120 as shown in FIG. 7. In this particular embodiment of FIG. 7, a DC power port 103′ is used to replace the AC power port 103 of FIG. 5 to directly forward DC power from an external DC power source (not shown) to the DC/DC converting circuit 120. The DC/DC converting circuit 102 then outputs DC power at suitable voltages to the first driving circuit 130, the second driving circuit 160, and the backlight module 150.

In FIG. 5, the power button 106 is adopted to control the power supplied to both of the display screens 101 and 101′. The power button 106 controls a switching module 100 that is interposed between the power port 103 and the AC/DC converting circuit 110 so as to control the power supplied to the double-sided display. In FIG. 6, the power button 106 and 106′ are adopted respectively to enable the display screen 101 and 101′. Concretely, the power button 106 controls the switching module 100 that is interposed between the DC/DC converting circuit 120 and the first driving circuit 130 to control the power supplied to the first driving circuit 130, and the power button 106′ controls another switching module 100′ that is interposed between the DC/DC converting circuit 120 and the second driving circuit 160 to control the power supplied to the second driving circuit 160.

In summary, the double-sided display provided in the preferred embodiment includes back-to-back mounted display screens 101 and 101′. The display screens 101 and 101′ share the backlight module 150 and are driven by the first driving circuit 130 and the second driving circuit 160 respectively. The first driving circuit 130 and the second driving circuit 160 receive data from the first data interface 104 and the second data interface 105 respectively. The first data interface 104 and the second data interface 105 may connect to a same computer or connect to different computers independently. When connected to a same computer, the double-sided display can serve as a presentation device. When connected to two different computers, the double-sided display can be employed as two independent displays. Under this configuration, the first driving circuit 130, the second driving circuit 160, and the backlighting module 150 receive the power supplied from the DC/DC converting circuit 120. The DC/DC converting circuit 120 receives the power supplied either from the AC/DC converting circuit 110 that is connected with the AC power port 103 as FIGS. 5, 6 depict or from the DC power port 103′ as FIG. 7 depicts.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A double-sided display comprising:
a first display screen and a second display screen mounted back-to-back;
a backlight module shared by the first display screen and the second display screen;
a first driving circuit and a second driving circuit for driving the first display screen and the second display screen respectively;
a first data interface and a second data interface for transmitting data from at most two computers to the first driving circuit and the second driving circuit correspondingly;
a DC/DC (direct current to direct current) converting circuit for outputting DC power at predetermined voltages to the backlight module, the first driving circuit, and the second driving circuit; and
a power port for transferring power from an external power source to the DC/DC converting circuit.

2. The double-sided display as claimed in claim 1, wherein the power port is a DC power port.

3. The double-sided display as claimed in claim 1, further comprising a AC/DC (alternating current to direct current) converting circuit for transferring power from the power port to the DC/DC converting circuit.

4. The double-sided display as claimed in claim 3, wherein the power port is an AC power port.

5. The double-sided display as claimed in claim 1, further comprising a power button for enabling the first display screen and the second display screen.

6. The double-sided display as claimed in claim 5, further comprising a switching module interposed between the power port and the DC/DC converting circuit, and controlled by the power button.

7. The double-sided display as claimed in claim 1, further comprising a first power button and a second power button for enabling the first display screen and the second display screen respectively.

8. The double-sided display as claimed in claim 7, further comprising a first switching module interposed between the DC/DC converting circuit and the first driving circuit, and controlled by the first power button, and a second switching module interposed between the DC/DC converting circuit and the second driving circuit, and controlled by the second power button.
